(19) United States
(12) Patent Application Publication
(10) Pub. No.: US 2023/0202267 A1
(43) Pub. Date: Jun. 29, 2023

(54) Automated Sunshade Assembly

(71) Applicant: Art Delao, Roseville, CA (US)

(72) Inventor: Art Delao, Roseville, CA (US)

(21) Appl. No.: 17/564,886

(22) Filed: Dec. 29, 2021

(51) Int. Cl. B60J 1/20

(52) U.S. Cl. CPC B60J 1/2019; B60J 1/2063; B60J 1/2077

(57) ABSTRACT

An automated sunshade assembly includes a cylinder positioned within a dashboard of a vehicle has the cylinder extending along a windshield of the vehicle. The cylinder has a slot extending into an interior of the cylinder and the slot being directed toward the windshield. A rod being rotatably disposed within the cylinder and a pair of drive units each of the drive units engages the rod for rotating the rod in a first direction or a second direction. A shield is rolled around the rod and the shield extends outwardly through the slot in the cylinder such that the shield is directed toward the windshield. The shield being driven upwardly to cover the windshield and the shield is retracted into the cylinder for storage. Furthermore, the shield is comprised of an opaque material to inhibit sunlight from passing into the vehicle from the windshield when the shield covers the windshield.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sunshade devices and more particularly pertains to a new sunshade device for protecting in interior of a vehicle from sunlight. The device includes a housing that is integrated into a dashboard of a vehicle and a shield that is positioned in the housing. The shield is driven upwardly along the windshield when the vehicle is turned off to inhibit sunlight from passing through the windshield when the vehicle is parked. Conversely, the shield is retracted into the housing when the vehicle is turned on to facilitate the vehicle to be driven normally.

### (2) Description of Related Art Including Information Disclosed Under 37 CFR 1.97 and 1.98

The prior art relates to sunshade devices including a shade device that includes a collapsible frame and a canopy coupled to the collapsible frame. The prior art discloses a sunshade system which includes a pair of rods, each being comprised of a plurality of articulated joints to facilitate the rods to be flexible. The prior art discloses a vehicle sunshade device that includes a roller which is vertically oriented on a windshield and a shield that extends laterally away from the roller for shading the windshield. The prior art discloses a vehicle sunshade device that includes a roller disposed at a base of a windshield, a shield rolled around the roller which can be pulled upwardly over the windshield and a plurality of magnets for retaining the shield over the windshield. The prior art discloses a motorized vehicle sunshade device that includes a remote control for remotely deploying or storing a sunshade for a windshield.

### BRIEF SUMMARY OF THE INVENTION

An embodiment of the disclosure meets the needs presented above by generally comprising a cylinder positioned within a dashboard of a vehicle has the cylinder extending along a windshield of the vehicle. The cylinder has a slot extending into an interior of the cylinder and the slot being directed toward the windshield. A rod is rotatably disposed within the cylinder and a pair of drive units each of the drive units engages the rod for rotating the rod in a first direction or a second direction. A shield is rolled around the rod and the shield extends outwardly through the slot in the cylinder such that the shield is directed toward the windshield. The shield is driven upwardly to cover the windshield and the shield is retracted into the cylinder for storage. Furthermore, the shield is comprised of an opaque material to inhibit sunlight from passing into the vehicle from the windshield when the shield covers the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of an automated sunshade assembly according to an embodiment of the disclosure.

FIG. 2 is a phantom in-use view of an embodiment of the disclosure.

FIG. 3 is a front phantom view of an embodiment of the disclosure.

FIG. 4 is a right side view of an embodiment of the disclosure.

FIG. 5 is a cross sectional view taken along line 5-5 of FIG. 3 of an embodiment of the disclosure.

FIG. 6 is a cross sectional view taken along line 6-6 of FIG. 2 of an embodiment of the disclosure.

### DETAILED DESCRIPTION OF THE INVENTION

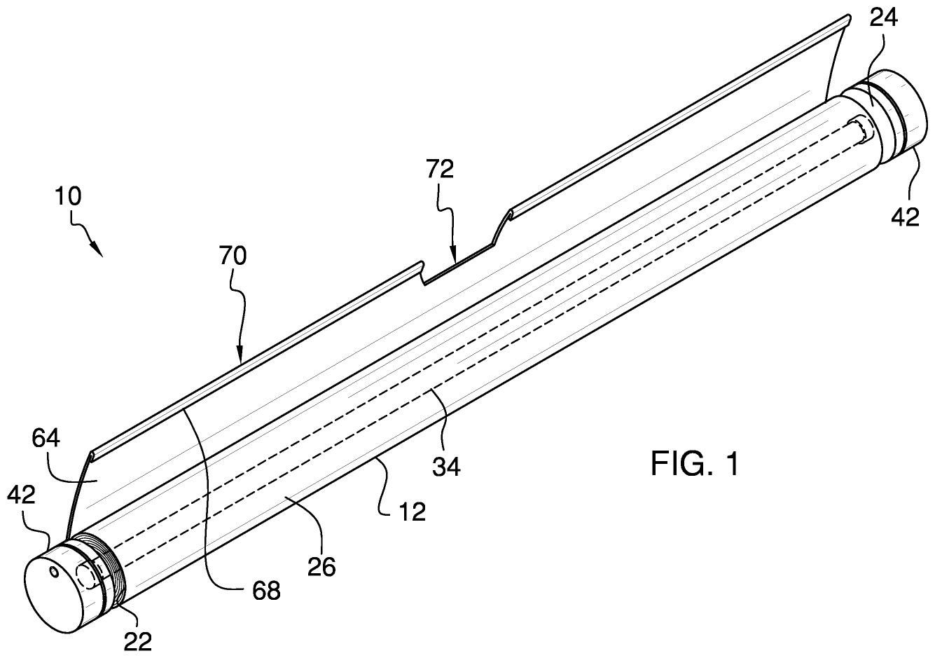

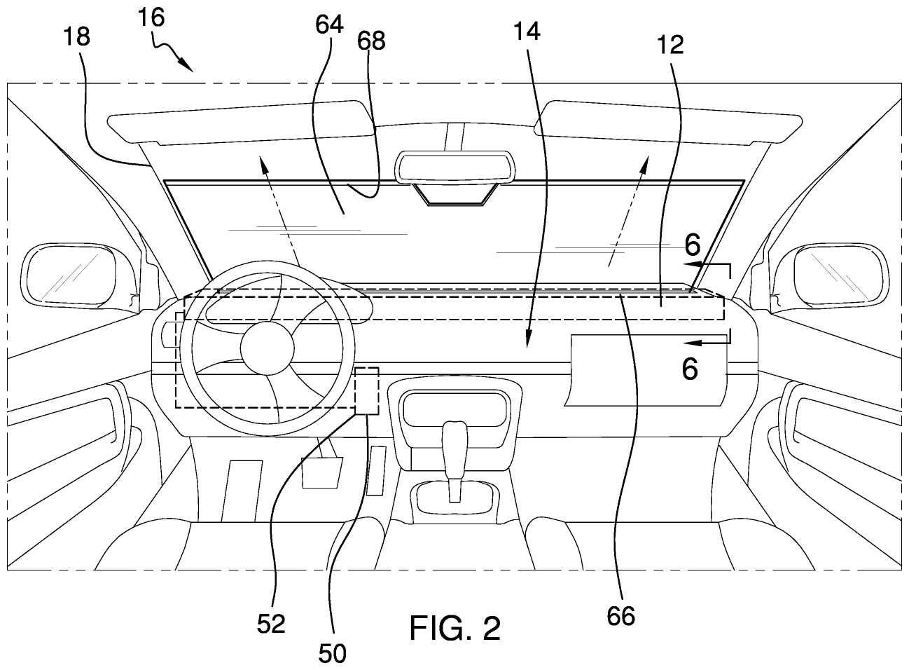

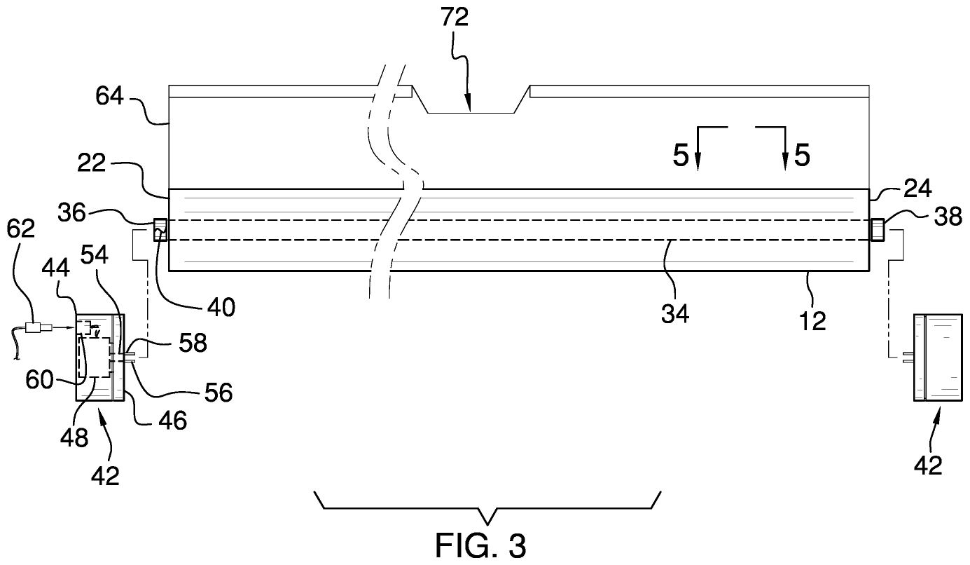

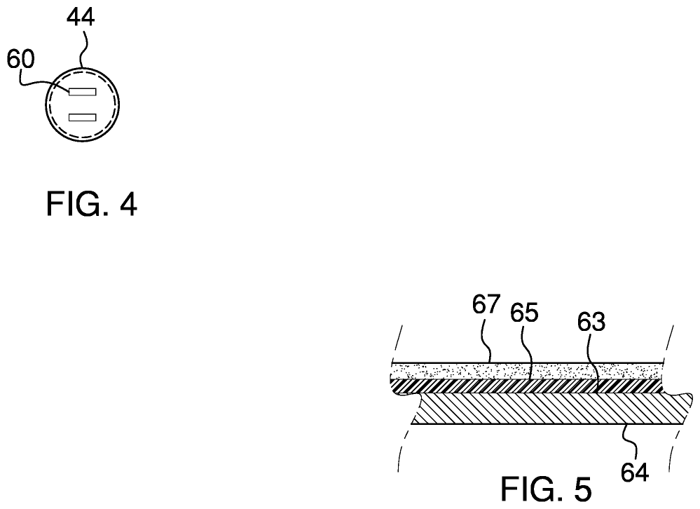

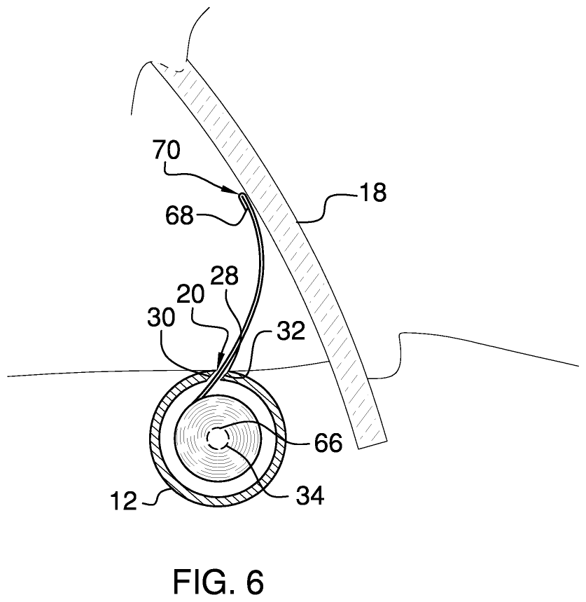

With reference now to the drawings, and in particular to FIGS. 1 through 6 thereof, a new sunshade device embodying the principles and concepts of an embodiment of the disclosure and generally designated by the reference numeral 10 will be described.

As best illustrated in FIGS. 1 through 6, the automated sunshade assembly 10 generally comprises a cylinder 12 is positioned within a dashboard 14 of a vehicle 16 having the cylinder 12 extending along a windshield 18 of the vehicle 16. The cylinder 12 has a slot 20 extending into an interior of the cylinder 12 and the slot 20 is directed toward the windshield 18. The cylinder 12 has a first end 22, a second end 24 and an outer wall 26 extending between the first end 22 and the second end 24. The cylinder 12 is elongated between the first end 22 and the second end 24, and the slot 20 extends through the outer wall 26. Furthermore, the slot 20 is elongated to extend substantially between the first end 22 and the second end 24. The slot 20 has a bounding edge 28 and the bounding edge 28 has a top side 30 and a bottom side 32. Each of the top side 30 and the bottom side 32 slopes at angle such that each of the top side 30 and the bottom side 32 lies on a plane which intersects the windshield 18 at an obtuse angle.

A rod 34 is rotatably disposed within the cylinder 12 and the rod 34 has a primary end 36, a secondary end 38 and an outside surface 40 extending between the primary end 36 and the secondary end 38. The rod 34 extends through each of the first end 22 and the second end 24 of the cylinder 12 such that each of the primary end 36 and the secondary end 38 is exposed. A pair of drive units 42 is provided and each of the drive units 42 is attached to the cylinder 12. Each of the drive units 42 engages the rod 34 and each of the drive units 42 is actuatable into a first condition having the rod 34 being rotated in a first direction. Additionally, each of the drive units 42 is actuatable into a second condition having the rod 34 being rotated in a second direction.

Each of the drive units 42 comprises a puck 44 which has a front surface 46 and a motor 48 which is positioned within the puck 44. The motor 48 is electrically coupled to a power source 50 comprising an electrical system of the vehicle 16 such that the motor 48 is in electrical communication with an ignition 52 of the vehicle 16. The motor 48 rotates in a first direction when the ignition 52 is turned off and the motor 48 rotates in a second direction when the ignition 52 is turned on. The motor 48 has a drive shaft 54 extending outwardly through the front surface 46 of the puck 44 and the drive shaft 54 has a coupling 56 which is integrated into a distal end 58 of the drive shaft 54.

The coupling 56 associated with each of the drive units 42 engages a respective one of the primary end 36 or the secondary end 38 of the rod 34. Additionally, the front surface 46 of the puck 44 associated with each of the drive units 42 abuts a respective one of the first end 22 or the second end 24 of the cylinder 12. The rod 34 is rotated in the first direction when the motor 48 rotates in the first direction. Conversely, the rod 34 is rotated in the second direction when the motor 48 rotates in the second direction. The motor 48 may comprise a two direction electric motor or other type of mechanical device. Each of the drive units 42 includes a power port 60 which is recessed into the puck 44 such that the power port 60 receives a power connection 62 in the vehicle 16. Additionally, the power port 60 is electrically coupled to the motor 48 thereby facilitating electrical communication between the power connection 62 and the motor 48.

A shield 64 is rolled around the rod 34 and the shield 64 extends outwardly through the slot 20 in the cylinder 12 such that the shield 64 is directed toward the windshield 18. The shield 64 is comprised of a resiliently deformable material, such as bistable stainless steel or other similar material, thereby facilitating the shield 64 to conform to the windshield 18 when the shield 64 is rolled outwardly from the cylinder 12. The shield 64 rolls around the rod 34 when the shield 64 is rolled inwardly into the cylinder 12. The shield 64 is driven upwardly to cover the windshield 18 when the drive units 42 are actuated into the first condition. Conversely, the shield 64 is retracted into the cylinder 12 for storage when the drive units 42 are actuated into the second condition. The shield 64 is comprised of an opaque material to inhibit sunlight from passing into the vehicle 16 from the windshield 18 when the shield 64 covers the windshield 18.

As is most clearly shown in FIG. 5, a protective layer 63 is bonded to a first surface 65 of the shield 64 and the protective layer 63 is comprised of an ultraviolet light resistant material. In this way the shield 64 is protected from degrading over time due to exposure to ultraviolet light from the sun. Continuing in FIG. 5, a cloth layer 67 is bonded to a protective layer 63 such that the cloth layer 67 completely covers the protective layer 63. The cloth layer 67 is comprised of a textile or other type of non abrasive material and the cloth layer 97 abuts the windshield 18 when the shield 64 is driven upwardly along the windshield 18.

The shield 64 has a coupled edge 66 and a free edge 68, and the coupled edge 66 is coupled to the outside surface 40 of the rod 34. The coupled edge 66 extends along a substantial distance between the primary end 36 and the secondary end 38 of the rod 34. The shield 64 is rolled onto itself adjacent to the free edge 68 to define a roll 70 extending along a full width of the shield 64. In this way the free edge 68 is inhibited from abrading the windshield 18 when the shield 64 is driven upwardly along the windshield 18. The shield 64 has a cut-out 72 extending from the free edge 68 toward the coupled edge 66 such that the cut-out 72 accommodates a rear view mirror when the shield 64 is deployed to cover the windshield 18. Additionally, the cut-out 72 is centrally positioned along a length of the free edge 68. The shield 64 is rolled around the rod 34 when the rod 34 rotates in the first direction and the shield 64 is unrolled from the rod 34 when the rod 34 rotates in the second direction.

In use, the motor 48 in each of the drive units 42 rotates in the first direction when the ignition 52 in the vehicle 16 is turned on. In this way the shield 64 is rolled around the rod 34 for storage thereby facilitating the vehicle 16 to be driven normally. The motor 48 in each of the drive units 42 rotates in the second direction when the ignition 52 in the vehicle 16 is turned off. In this way the shield 64 is driven upwardly along the windshield 18 when the vehicle 16 is parked. Thus, the shield 64 inhibits sunlight from passing through the windshield 18 while the vehicle 16 is parked.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated sunshade assembly for automatically shading a windshield in a vehicle, said assembly comprising:
a cylinder being positioned within a dashboard of a vehicle having said cylinder extending along a windshield of the vehicle, said cylinder having a slot extending into an interior of said cylinder, said slot being directed toward the windshield;
a rod being rotatably disposed within said cylinder;
a pair of drive units, each of said drive units being attached to said cylinder, each of said drive units engaging said rod, each of said drive units being actuatable into a first condition having said rod being rotated in a first direction, each of said drive units being actuatable into a second condition having said rod being rotated in a second direction; and
a shield being rolled around said rod, said shield extending outwardly through said slot in said cylinder such that said shield is directed toward the windshield, said shield being comprised of a resiliently deformable material thereby facilitating said shield to conform to the windshield when said shield is rolled outwardly from said cylinder and roll around said rod when said shield is rolled inwardly into said cylinder, said shield being driven upwardly to cover the windshield when said drive units are actuated into said first condition, said shield being retracted into said cylinder for storage when said drive units are actuated into said second condition, said shield being comprised of an opaque material wherein said shield is configured to inhibit sunlight from passing into the vehicle from the windshield when said shield covers the windshield.

2. The assembly according to claim 1, wherein:
said cylinder has a first end, a second end and an outer wall extending between said first end and said second end, said cylinder being elongated between said first end and said second end, said slot extending through said outer wall, said slot being elongated to extend substantially between said first end and said second end, said slot having a bounding edge, said bounding edge having a top side and a bottom side, each of said top side and said bottom side being sloping at angle such that each of said top side and said bottom side lies on a plane which intersects the windshield at an obtuse angle; and
said rod has a primary end, a secondary end and an outside surface extending between said primary end and said secondary end, said rod extending through each of said first end and said second end of said cylinder such that each of said primary end and said secondary end is exposed.

3. The assembly according to claim 2, wherein each of said drive units comprises:
a puck having a front surface; and
a motor being positioned within said puck, said motor being electrically coupled to a power source comprising an electrical system of the vehicle such that said motor is in electrical communication with an ignition of the vehicle, said motor rotating in a first direction when the ignition is turned off, said motor rotating in a second direction when the ignition is turned on, said motor having a drive shaft extending outwardly through said front surface of said puck, said drive shaft having a coupling being integrated into a distal end of said drive shaft, said coupling associated with each of said drive units engaging a respective one of said primary end or said secondary end of said rod having said front surface of said puck associated with each of said drive units abutting a respective one of said first end or said second end of said cylinder.

4. The assembly according to claim 3, wherein:
said rod is rotated in said first direction when said motor rotates in said first direction; and
said rod is rotated in said second direction when said motor rotates in said second direction.

5. The assembly according to claim 3, wherein each of said drive units includes a power port being recessed into said puck such that said power port receives a power connection in the vehicle, said power port being electrically coupled to said motor thereby facilitating electrical communication between the power connection and said motor.

6. The assembly according to claim 2, wherein said shield has a coupled edge and a free edge, said coupled edge being coupled to said outside surface of said rod, said coupled edge extending along a substantial distance between said primary end and said secondary end of said rod, said shield being rolled onto itself adjacent to said free edge to define a roll extending along a full width of said shield thereby inhibiting the windshield from being abraded by said free edge.

7. The assembly according to claim 6, wherein said shield has a cut-out extending from said free edge toward said coupled edge such that said cut-out accommodates a rear view mirror when said shield is deployed to cover the windshield, said cut-out being centrally positioned along a length of said free edge.

8. The assembly according to claim 4, wherein said shield is rolled around said rod when said rod rotates in said first direction, said shield being unrolled from said rod when said rod rotates in said second direction.

9. An automated sunshade assembly for automatically shading a windshield in a vehicle, said assembly comprising:
a cylinder being positioned within a dashboard of a vehicle having said cylinder extending along a windshield of the vehicle, said cylinder having a slot extending into an interior of said cylinder, said slot being directed toward the windshield, said cylinder having a first end, a second end and an outer wall extending between said first end and said second end, said cylinder being elongated between said first end and said second end, said slot extending through said outer wall, said slot being elongated to extend substantially between said first end and said second end, said slot having a bounding edge, said bounding edge having a top side and a bottom side, each of said top side and said bottom side being sloping at angle such that each of said top side and said bottom side lies on a plane which intersects the windshield at an obtuse angle;
a rod being rotatably disposed within said cylinder, said rod having a primary end, a secondary end and an outside surface extending between said primary end and said secondary end, said rod extending through each of said first end and said second end of said cylinder such that each of said primary end and said secondary end is exposed;
a pair of drive units, each of said drive units being attached to said cylinder, each of said drive units engaging said rod, each of said drive units being actuatable into a first condition having said rod being rotated in a first direction, each of said drive units being actuatable into a second condition having said rod being rotated in a second direction, each of said drive units comprising:
a puck having a front surface;
a motor being positioned within said puck, said motor being electrically coupled to a power source comprising an electrical system of the vehicle such that said motor is in electrical communication with an ignition of the vehicle, said motor rotating in a first direction when the ignition is turned off, said motor rotating in a second direction when the ignition is turned on, said motor having a drive shaft extending outwardly through said front surface of said puck, said drive shaft having a coupling being integrated into a distal end of said drive shaft, said coupling associated with each of said drive units engaging a respective one of said primary end or said secondary end of said rod having said front surface of said puck associated with each of said drive units abutting a respective one of said first end or said second end of said cylinder, said rod being rotated in said first direction when said motor rotates in said first direction, said rod being rotated in said second direction when said motor rotates in said second direction; and
a power port being recessed into said puck such that said power port receives a power connection in the vehicle, said power port being electrically coupled to said motor thereby facilitating electrical communication between the power connection and said motor;
a shield being rolled around said rod, said shield extending outwardly through said slot in said cylinder such that said shield is directed toward the windshield, said shield being comprised of a resiliently deformable material thereby facilitating said shield to conform to the windshield when said shield is rolled outwardly from said cylinder and roll around said rod when said shield is rolled inwardly into said cylinder, said shield being driven upwardly to cover the windshield when said drive units are actuated into said first condition, said shield being retracted into said cylinder for storage when said drive units are actuated into said second condition, said shield being comprised of an opaque material wherein said shield is configured to inhibit sunlight from passing into the vehicle from the windshield when said shield covers the windshield, said shield having a coupled edge and a free edge, said coupled edge being coupled to said outside surface of said rod, said coupled edge extending along a substantial distance between said primary end and said secondary end of said rod, said shield being rolled onto itself adjacent to said free edge to define a roll extending along a full width of said shield thereby inhibiting the windshield from being abraded by said free edge, said shield having a cut-out extending from said free edge toward said coupled edge such that said cut-out accommodates a rear view mirror when said shield is deployed to cover the windshield, said cut-out being centrally positioned along a length of said free edge, said shield being rolled around said rod when said rod rotates in said first direction, said shield being unrolled from said rod when said rod rotates in said second direction.
